(19) United States
(12) Patent Application Publication
(10) Pub. No.: US 2025/0347578 A1
(43) Pub. Date: Nov. 13, 2025

(54) LEAKAGE DETECTION SYSTEM

(71) Applicant: SAUDI ARABIAN OIL COMPANY, Dhahran (SA)

(72) Inventors: Mutlaq F. Azmi, As Saffaniyah (SA); Basil S. AbuHadi, Jeddah (SA); Muhammed A. Alaqeel, Madinah (SA); Fawaz S. Alshammari, Al Ahmadi (KW)

(73) Assignee: SAUDI ARABIAN OIL COMPANY, Dhahran (SA)

(21) Appl. No.: 18/658,501

(22) Filed: May 8, 2024

(51) Int. Cl. G01M 3/26; F17D 5/02; G05B 23/02

(52) U.S. Cl. CPC G01M 3/26; F17D 5/02; G05B 23/027; G05B 23/0275

(57) ABSTRACT

A method of detecting fluid leakage in an industrial facility is disclosed. The method includes installing a set of sensors at fluid sensor locations in a pipeline network of the industrial facility, identifying a portion of the pipeline network as a leakage detection segment in the industrial facility, where all input flowpaths, all fluid storages, and all output flowpaths of the portion of the pipeline network belong to the fluid sensor locations, generating, using the set of sensors, fluid sensor measurements of the leakage detection segment, analyzing, based on a mass balance criterion, the fluid sensor measurements to generate a mass balance analysis result, and performing, based on the analysis result, a maintenance operation of the industrial facility.

### BACKGROUND

An industrial facility often includes fluid transport and storage network of pipes, storage tanks, pressure vessels, valves, and other connections. Fluid leakage from the fluid transport and storage network may result in material waste and potentially hazardous conditions of the industrial plant. Therefore, detecting and repairing potentially wasteful and/or hazardous fluid leaks is an important task of operating industrial facilities.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, the invention relates to a method of detecting fluid leakage in an industrial facility. The method includes installing a plurality of sensors at a plurality of fluid sensor locations in a pipeline network of the industrial facility, identifying a portion of the pipeline network as a leakage detection segment in the industrial facility, wherein all input flowpaths, all fluid storages, and all output flowpaths of the portion of the pipeline network belong to the plurality of fluid sensor locations, generating, using the plurality of sensors, a plurality of fluid sensor measurements of the leakage detection segment, analyzing, based on a mass balance criterion, the plurality of fluid sensor measurements to generate a mass balance analysis result, and performing, based on the analysis result, a maintenance operation of the industrial facility.

In general, in one aspect, the invention relates to a leakage detection engine for detecting fluid leakage in an industrial facility. The leakage detection engine includes a computer processor, and memory storing instructions, when executed by the computer processor, comprising functionality for identifying a portion of a pipeline network as a leakage detection segment in the industrial facility, wherein all input flowpaths, all fluid storages, and all output flowpaths of the leakage detection segment belong to a plurality of fluid sensor locations where a plurality of sensors are installed in the pipeline network, receiving, from the plurality of sensors, a plurality of fluid sensor measurements of the leakage detection segment, analyzing, based on a mass balance criterion, the plurality of fluid sensor measurements to generate a mass balance analysis result, and facilitating, based on the analysis result, a maintenance operation of the industrial facility.

leakage detection engine industrial facility that includes a pipeline network comprising a plurality of fluid sensor locations where a plurality of sensors are installed, and a leakage detection engine comprising functionality for identifying a portion of the pipeline network as a leakage detection segment in the industrial facility, wherein all input flowpaths, all fluid storages, and all output flowpaths of the leakage detection segment belong to the plurality of fluid sensor locations in the pipeline network, receiving, from the plurality of sensors, a plurality of fluid sensor measurements of the leakage detection segment, analyzing, based on a mass balance criterion, the plurality of fluid sensor measurements to generate a mass balance analysis result, and facilitating, based on the analysis result, a maintenance operation of the industrial facility, wherein the plurality of fluid sensor measurements comprise an input fluid quantity through each input flowpath into the leakage detection segment, a stored fluid quantity in each fluid storage in the leakage detection segment, and an output fluid quantity through each output flowpath from the leakage detection segment.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A and 1B show a system in accordance with one or more embodiments.

FIG. 2 shows a flowchart in accordance with one or more embodiments.

FIG. 3 shows an example in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The embodiments disclosed herein describe a system and method that detects leakage in an industrial facility by calculating the mass balance of a pipeline network using existing installed sensors and level transmitters with a variety of fluid measuring options and built-in unit conversion tool. The industrial facility is divided into leakage detection segments based on flowpath inputs, fluid storages, and flowpath outputs. The flowpath is a sequence of pipes and connections where fluids flow through from an upstream location to a downstream location in the pipeline network. In one or more embodiments, the fluid measuring options are based on flowrate, pressure drop, fluid level, and temperature measurements.

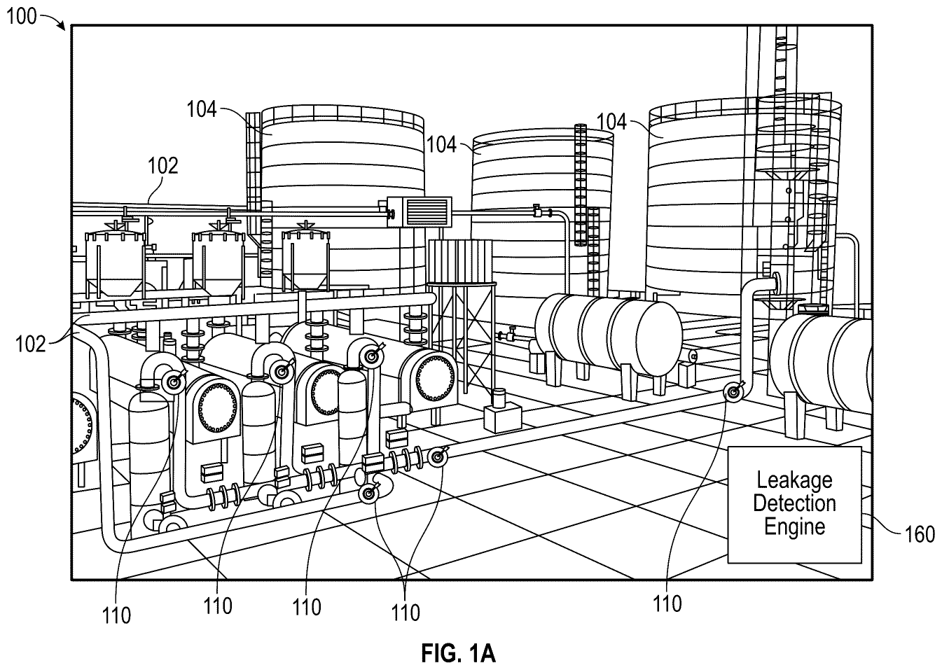

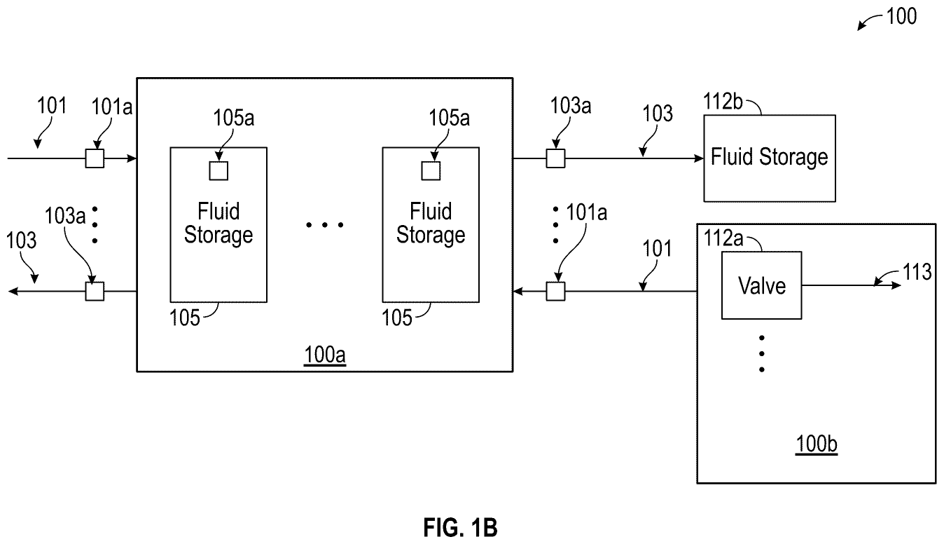

FIG. 1A shows an exemplary industrial facility (100) in accordance with one or more embodiments. In one or more embodiments, one or more of the modules and/or elements shown in FIG. 1A may be omitted, repeated, combined and/or substituted, or disposed at different locations than depicted. Accordingly, embodiments disclosed herein should not be considered limited to the specific arrangements of modules and/or elements shown in FIG. 1A.

As shown in FIG. 1A, the facility (100) may be a crude oil or natural gas storage facility, a gas-oil separation plant, a hydrocarbon refinery, a chemical production plant, or other fluid processing facilities. Such facilities are characterized by a network of pipes (102), storage tanks (104), pressure vessels, valves, and other connections that are collectively referred to as a pipeline network of the industrial facility (100). More specifically, the pipeline network is a fluid transport and storage network. In some case, these components may be constructed from materials or may be coated with finishes that are designed to resist corrosion. However, despite these design precautions, leakage detection protocols are routinely performed to provide forewarning of potential wasteful and/or hazardous leakages.

In one or more embodiments, the leakage detection protocol involves the identification of a set of fluid sensor locations (110) throughout the facility (100). The fluid sensor locations (110) are locations where sensors are installed that measure the flowrate, pressure drop, temperature, or fluid level of the pipes (102), storage tanks (104), pressure vessels, valves, and other connections. In one or more embodiments, these sensors are pre-installed at the fluid sensor locations (110) during construction of the facility (100). In this context, the sensors installed at the fluid sensor locations (110) are referred to as existing installed sensors. Typically, there are ten thousand or more fluid sensor locations (110) having existing installed sensors within a single facility (100).

In one or more embodiments, the leakage detection protocol further involves the identification of a leakage detection segment in the facility (100). The leakage detection segment is a portion of the pipes (102), storage tanks (104), pressure vessels, valves, and connections in the facility (100) where all input flowpaths, output flowpaths, and fluid storages have existing installed sensors and thus belong to the fluid sensor locations (110). In other words, any input fluid flow into the leakage detection segment, any output fluid flow from the leakage detection segment, and any fluid storage level in the leakage detection segment are measured using existing installed sensors. For example, the input fluid flow and output fluid flow may be measured using flow meters installed at input and output pipes, and the fluid storage level may be measured using level transmitters installed in the storage tanks. A flow meter is a device that measures how much liquid or gas moves through a pipeline in a given period of time. Level transmitters are sensors used to measure stored fluid levels (i.e., a level or height of fluid surface inside the storage tank) in storage tanks, vessels, silos, etc.

In some embodiments, the facility (100) further includes a leakage detection engine (160). For example, the leakage detection engine (160) may include hardware and/or software with functionality for analyzing measurements of the existing installed sensors to generate detection results. For example, the measurement data of the existing installed sensors may be recorded and provided to the leakage detection engine (160) for analysis. In one or more embodiments, the measurement data of one or more existing installed sensors is recorded by a human operator and inputted to the leakage detection engine (160). In one or more embodiments, the measurement data of one or more existing installed sensors is automatically transmitted to the leakage detection engine (160) via wired or wireless communication network of the facility (100) without operator intervention.

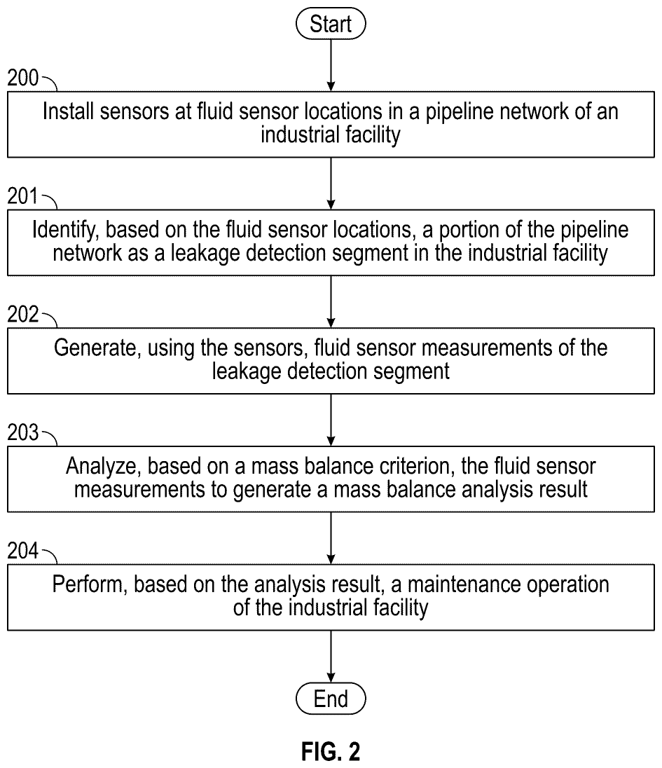

Based on the received measurement data of the existing installed sensors, the leakage detection engine (160) generates detection results that may indicates fluid leakage or sensors' false measurement by calculating the complete leakage detection segment's input/output flows and total fluid storage volume. When attempting to detect leakage, the flowrate of all input/output flowpaths (e.g., pipes, valves, or other connections) are compared with fluid storage levels (e.g., of storage tanks or pressure vessels) to evaluate whether leakage has occurred in any leakage detection segment. The evaluation may also facilitate detecting faulty readings of the existing installed sensors, e.g., when the volume of storage increases while the output flowrate is greater than or equal to the input flowrate. The leakage detection engine (160) includes a built-in conversion tool configured to convert between mismatching measurement units. In one or more embodiments, the detection results may be generated by the leakage detection engine (160) continuously, periodically, according to a pre-defined time schedule, or as triggered by a pre-defined event or a user command. Examples of the pre-defined events may include when flowrate measured at certain output pipe or fluid level measured at certain fluid storage tank anywhere in the facility (100) becomes less than a pre-defined lower limit. In one or more embodiments, the generation of a detection result pertaining to a leakage detection segment may be triggered by a pre-defined event external to the leakage detection segment, such as a flowrate of a pipe or a fluid level of a storage tank external to the leakage detection segment becoming less than the pre-defined lower limit. In particular, the leaking flowpath internal to the leakage detection segment is ultimately interconnected with the pipe or storage tank external to the leakage detection segment where the measured data falls below the pre-defined limit. In one or more embodiments, the leakage detection engine (160) performs these functionalities using the method described in reference to FIG. 2 below.

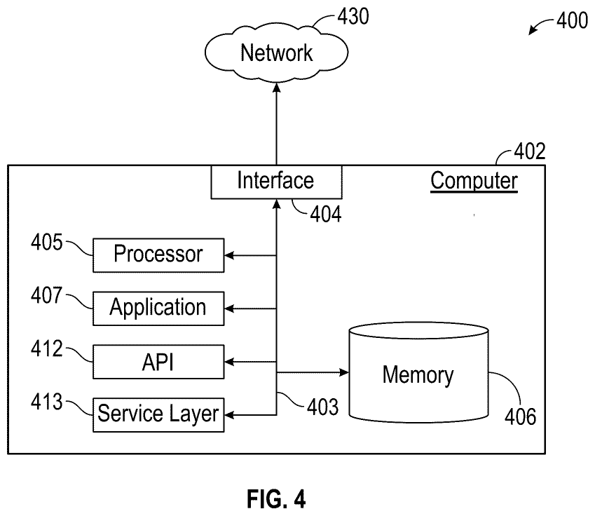

While the leakage detection engine (160) is shown in FIG. 1A as located at an industrial facility, embodiments are contemplated where the leakage detection engine (160) is located away from the industrial facility. In some embodiments, the leakage detection engine (160) may include a computer system that is similar to the computer system (400) described below with regard to FIG. 4 and the accompanying description.

FIG. 1B shows an exemplary leakage detection segment (100a) in accordance with one or more embodiments. For example, the leakage detection segment (100a) may be part of the facility (100) depicted in FIG. 1A above. In one or more embodiments, one or more of the modules and/or elements shown in FIG. 1B may be omitted, repeated, combined and/or substituted, or disposed at different locations than depicted. Accordingly, embodiments disclosed herein should not be considered limited to the specific arrangements of modules and/or elements shown in FIG. 1B.

As shown in FIG. 1B, the leakage detection segment (100a) includes multiple input flowpaths (101), multiple fluid storages (105), and multiple output flowpaths (103). These input flowpaths (101), fluid storages (105), and multiple output flowpaths (103) are interconnected through pipelines, valves, and other connections not explicitly shown. Each input flowpath (101) has a flowmeter (101a), each fluid storage (105) is installed a level transmitter (105a), and each output flowpath (103) is installed a flowmeter (103a). Specifically, the leakage detection segment (100a) does not include any input flowpath, fluid storage, and/or output flowpath that are not installed with an existing installed sensor capable of measuring respective flowrates and/or fluid levels. For example, the valve (112a) is excluded from the leakage detection segment (100a) because the output flowpath (113) does not have any flowmeter installed and thus does not belong to the fluid sensor locations (110). However, the valve (112a) may belong to a separate leakage detection segment (100b) where the output flowpath (113) of the leakage detection segment (100a) is an internal flowpath of the leakage detection segment (100b). In another example, the fluid storage (112b) is excluded from the leakage detection segment (100a) because no level transmitter or other level measure device is installed and thus the fluid storage (112b) does not belong to the fluid sensor locations (110).

TABLE 1 below lists examples of the leakage detection segment (100a) where FM stands for flowmeter and LT stands for level transmitter. For example, the leakage detection segment example #1 includes one FM (101a) installed in a single input flowpath (101) and one FM (103a) installed in a single output flowpath (103) without including any fluid storage nor level transmitter. In another example, the leakage detection segment example #4 includes one FM (101a) installed in a single input flowpath (101), one LT (105a) installed in a single fluid storage container (105), and one FM (103a) installed in a single output flowpath (103). In yet another example, the leakage detection segment example #6 includes three FMs (101a) installed in three corresponding input flowpaths (101), two LTs (105a) installed in two corresponding fluid storage containers (105), and two FMs (103a) installed in two corresponding output flowpaths (103).

TABLE 1

| Leakage detection | Input | Fluid Storage | Output |
|---|---|---|---|
| Segment Example | Flowpath | Container | Flowpath |
| #1 | 1 FM | | 1 FM |
| #2 | 1 FM | 1 LT | |
| #3 | | 1 LT | 1 FM |
| #4 | 1 FM | 1 LT | 1 FM |
| #5 | 2 FM | 1 LT | 3 FM |
| #6 | 3 FM | 2 LT | 2 FM |

In one or more embodiments, the leakage detection segment (100a) analyzes the sensor measurement data based on a mass conservation principal. In the perfect scenario there is no leakage, the mass conservation of the leakage detection segment is given by Eq. (1) below.

$$0 = ( \sum Storage mass - \sum Storage massafter ) + ( \sum flowing in mass - \sum flowing out mass ) \qquad Eq . ( 1 )$$

In Eq. (1), ΣStorage mass denotes the initial sum of all stored fluid quantity in all fluid storages in the leakage detection segment at the beginning of the testing period, ΣStorage massafter denotes the final sum of all stored fluid quantity in all fluid storages in the leakage detection segment at the end of the testing period, Σflowing in mass denotes the total sum of fluid quantity flowing in through all input flowpaths of the leakage detection segment during the testing period, and Σflowing out mass denotes the total sum of fluid quantity flowing out through all output flowpaths of the leakage detection segment during the testing period. Although Eq. (1) refers to the fluid quantity as mass, the fluid quantity can correspond to either weight or volume.

In one or more embodiments, the leakage detection segment (100a) generates the leakage detecting results by calculating the change of the storage mass which equals to the difference between the incoming mass and the outgoing mass. By comparing this difference with the fluid level change measured using the level transmitters in all fluid storages, the leakage detecting results can indicate the leakage occurrence or the sensor failures in the following scenarios.

In the scenario 1 where there is no leakage detected, Eq. (2) holds true as below.

$$( \sum Storage mass + ( \sum flowing in mass - \sum flowing out mass ) = \sum Storage massafter \qquad Eq . ( 2 )$$

In the scenario 2, where there is either a leakage or one or more sensors giving faulty readings, Eq. (3) holds true as below.

$$( \sum Storage mass + ( \sum flowing in mass - \sum flowing out mass ) > \sum Storage massafter \qquad Eq . ( 3 )$$

In the scenario 3, where there are faulty readings in one or more sensors, Eq. (4) holds true as below.

$$\sum Storage mass + ( \sum flowing in mass - \sum flowing out mass ) < \sum Storage massafter \qquad Eq . ( 4 )$$

When the leakage detecting results indicate either scenario 2 or scenario 3, the leakage detection engine generates an alarm and control signals to shut off control valves to isolate the leakage detection segment from the remaining fluid transport and storage network of the industrial facility. The facility maintenance or repair crew are then dispatched in response to the alarm to perform root cause analysis and maintenance/repair tasks to correct the pipeline leakage and/or faulty sensors.

FIG. 2 shows a process flowchart for detecting fluid leakage in an industrial facility in accordance with one or more embodiments. In one or more embodiments, the process flowchart is performed using one or more components as described in FIGS. 1A-1B. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Step 200, a set of sensors are installed at a number of fluid sensor locations in a pipeline network of the industrial facility. The pipeline network is a fluid transport and storage network where the sensors measure fluid flow quantities in flowpaths and fluid storage quantities in storage tanks. In one or more embodiments, the fluid sensor locations and the connection diagram of the pipeline network are recorded in a maintenance databased of the industrial facility.

In Step 201, a portion of the pipeline network is identified as a leakage detection segment in the industrial facility. The leakage detection segment is identified based on the fluid sensor locations where all input flowpaths, all fluid storages, and all output flowpaths of the identified portion of the pipeline network belong to the fluid sensor locations. In one or more embodiments, the leakage detection segment is identified by analyzing the fluid sensor locations and the connection diagram of the pipeline network that are recorded in the maintenance databased of the industrial facility.

In Step 202, a set of fluid sensor measurements of the leakage detection segment are generated using the set of sensors. In one or more embodiments, the set of fluid sensor measurements includes an input fluid quantity through each input flowpath into the leakage detection segment, a stored fluid quantity in each fluid storage in the leakage detection segment, and an output fluid quantity through each output flowpath from the leakage detection segment. In one or more embodiments, multiple sets of fluid sensor measurements are generated for multiple leakage detection segments of the industrial facility continuously, intermittently, according to a pre-determined schedule, in response to a pre-determined event or a user command or based on other pre-determined criteria.

In Step 203, the set of fluid sensor measurements are analyzed based on a mass balance criterion to generate a mass balance analysis result. In one or more embodiments, the analysis is initiated in response to a potential fluid leakage in the industrial facility without any detail as to likely location of the potential leakage. In a first scenario, it is determined that no fluid leakage is detected in a particular leakage detection segment based on the mass balance analysis result of (ΣStorage mass+(Σflowing in mass−Σflowing out mass)=ΣStorage massafter. In response to determining that no fluid leakage is detected in this particular leakage detection segment, a different set of fluid sensor measurements of another leakage detection segment are analyzed in a continued attempt to isolate the potential fluid leakage in the industrial facility.

In the above analysis result formula, ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

In a second scenario, it is determined that a fluid leakage within the leakage detection segment or a faulty sensor measurements in the set of fluid sensor measurements is detected based on the mass balance analysis result of (ΣStorage mass+(Σflowing in mass−Σflowing out mass)>ΣStorage massafter. As the fluid leakage and faulty sensor measurement are both likely, this detection is referred to as a selective detection where further root cause analysis is performed to definitively determine whether the mass balance analysis result indicates the fluid leakage or faulty sensor measurement.

In a third scenario, it is determined that a faulty sensor measurements in the set of fluid sensor measurements is definitively detected based on the mass balance analysis result of (ΣStorage mass+(Σflowing in mass−Σflowing out mass)<ΣStorage massafter.

In Step 204, a maintenance operation of the industrial facility is performed based on the analysis result. In one or more embodiments, in response to selectively detecting the fluid leakage or the faulty sensor measurements, an alarm and control signals are generated to isolate the leakage detection segment from a remaining portion of the pipeline network. Accordingly, a root cause analysis is performed, in response to the alarm, to facilitate the maintenance operation for correcting the fluid leakage or the faulty sensor measurements. For example, each flowmeter and level transmitter in the leakage detection segment may be individually inspected and verified. In the scenario where all sensors are inspected and verified as functioning properly, a maintenance or repair crew may be dispatched to inspect all components in the leakage detection segment to isolate specific location of the fluid leakage. In another example, a faulty sensor may be identified and replaced based on the root cause analysis indicating that the alarm is not related to actual fluid leakage. In response to definitively detecting the faulty sensor measurements, a root cause analysis is further performed to facilitate the maintenance operation by isolating the faulty sensor in the leakage detection segment.

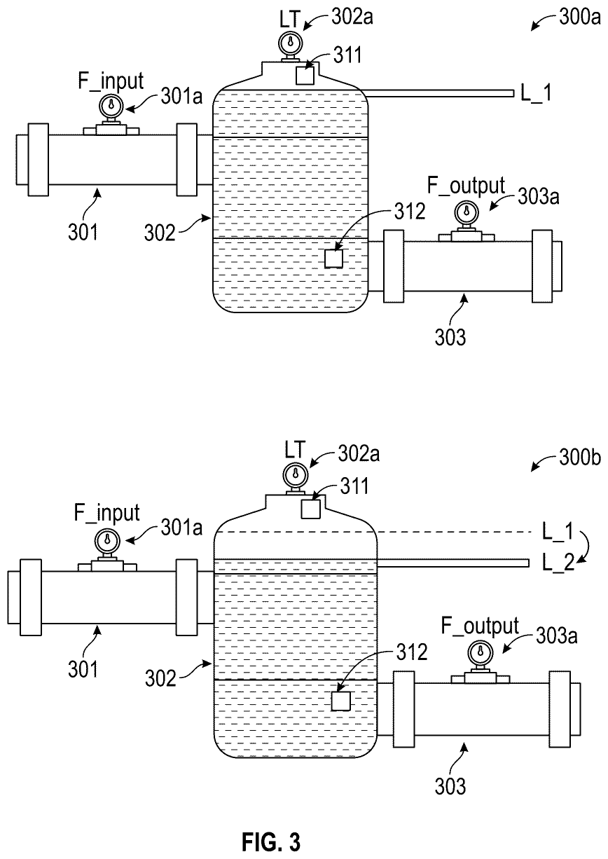

FIG. 3 shows an example in accordance with one or more embodiments. The example shown in FIG. 3 is based on the system and method described in reference to FIGS. 1A, 1B, and 2 above. In one or more embodiments, one or more of the modules and/or elements shown in FIG. 3 may be omitted, repeated, combined and/or substituted. Accordingly, embodiments disclosed herein should not be considered limited to the specific arrangements of modules and/or elements shown in FIG. 3.

FIG. 3 shows a schematic diagram of two configurations of the leakage detection segment example #4 listed in TABLE 1 above. As shown in FIG. 3, the leakage detection segment example #4 includes an input flowpath (301), a fluid storage (302), and an output flowpath (303) that are installed with an input flowmeter (FM) (301a), a level transmitter (LT) (302a), and an output FM (303a), respectively. The fluid storage (302) may include a tank, drum, or other type of fluid container with dimensions, e.g., of 10 meters in radius and 20 meters in height.

Using the leakage detection engine described above, the detection results are evaluated for 10 minutes where the configuration (300a) and the configuration (300b) correspond to the starting configuration and ending configuration, respectively, through the 10-minute evaluation period. During the 10-minute evaluation period, the output FM (303a) measures a constant flowrate of F_output=11008 Gallon (Imperial) Per Minute and the input FM (301a) measures a constant flowrate of F_input=15840 Gallon (Imperial) Per Day. These flowrate readings are automatically converted to F_output=50.04347 Meter³/Minute and F_input=0.050007 Meter³/Minute. With the simplified assumption that the flowrates are constant throughout the 10-minute evaluation period, Σflowing in mass −Σflowing out mass corresponds to a volumetric difference of (0.50007−500.4347) Meter³=−499.934 Meter³. During the same 10-minute evaluation period, the reading of the level transmitter (302a) changes/reduces from L_1=10 Meter to L_2=8.5 Meter. Based on the height (20 Meter) and radius (10.3 Meter) of the fluid storage tank (302), ΣStorage mass−ΣStorage massafter corresponds to a volumetric difference of (3332.916-2832.978) Meter³=499.938 Meter³. Combining the two volumetric differences results in Σflowing in mass −Σflowing out mass+ΣStorage mass−ΣStorage massafter=499.938 Meter³+(−499.934) Meter³=0.004 Meter³.

In other words, Eq. (3) above holds true and there is either a small leakage or small faulty sensor readings. According to Step 204 described in reference to FIG. 2 above, an alarm and control signals are generated to isolate the leakage detection segment #4 from a remaining portion of the pipeline network. Corresponding root cause analysis and maintenance operation are also performed as described in Step 204.

The source of error in the leak detection calculation above may be a result of sensor accuracy, data transfer accuracy, data compression settings, exception settings, fluid density, and material imbalance due to foam, interface, or sediments.

In addition to using flowmeters and level transmitters within the leakage detection segment #4, the leakage calculation may be performed using other sensors such as temperature or pressure sensors. For example, two pressure sensors can be used to replace a flowmeter to calculate non-compressible fluid using Eq. (5) below.

$$Q = K \sqrt{Δ P \times S} \qquad Eq . ( 5 )$$

In Eq. (5), Q denotes the flowrate of a flowpath between the two pressure sensors, K denotes the flow factor of the flowpath between the two pressure sensors, S denotes the specific gravity of the fluid, and ΔP denotes the differential pressure reading of the downstream pressure sensor reading minus the upstream pressure sensor reading.

In another example, pressure sensors (311, 312) can be used to replace the level transmitter (302a) for the non-atmospheric tank (i.e., pressurized tank) (302) using Eq. (6) below.

$$H = \frac{{P}_{2} - {P}_{1}}{dn \times g} \qquad Eq . ( 6 )$$

In Eq. (6), H denotes the level/height of the liquid surface referenced from the depth of an immersed pressure sensor (312) immersed in the stored liquid, P₂ denotes the reading of the immersed pressure sensor (312), P₁ denotes the reading of the pressure sensor (311) disposed above the liquid surface in the storage tank (302), dn denotes the liquid density, and g denotes the gravitational acceleration that is approximately 9.8 m/s².

As noted above, once any leakage is detected in the leakage detection segment #4, the leakage detection engine generates an alarm and control signals to shut off control valves to isolate the leakage detection segment #4 from the remaining fluid transport and storage network of the industrial facility.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

What is claimed is:

1. A method of detecting fluid leakage in an industrial facility, comprising:
installing a plurality of sensors at a plurality of fluid sensor locations in a pipeline network of the industrial facility;
identifying a portion of the pipeline network as a leakage detection segment in the industrial facility, wherein all input flowpaths, all fluid storages, and all output flowpaths of the portion of the pipeline network belong to the plurality of fluid sensor locations;
generating, using the plurality of sensors, a plurality of fluid sensor measurements of the leakage detection segment;
analyzing, based on a mass balance criterion, the plurality of fluid sensor measurements to generate a mass balance analysis result; and
performing, based on the analysis result, a maintenance operation of the industrial facility.

2. The method of claim 1, wherein the plurality of fluid sensor measurements comprise:
an input fluid quantity through each input flowpath into the leakage detection segment;
a stored fluid quantity in each fluid storage in the leakage detection segment; and
an output fluid quantity through each output flowpath from the leakage detection segment.

3. The method of claim 1, further comprising:
determining, based on the mass balance analysis result of (ΣStorage mass+(Σflowing in mass−Σflowing out mass)=ΣStorage massafter, that no fluid leakage is detected,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

4. The method of claim 1, further comprising:
detecting, based on the mass balance analysis result of (ΣStorage mass+(Σflowing in mass−Σflowing out mass)>ΣStorage massafter, the fluid leakage within the leakage detection segment or a faulty sensor measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

5. The method of claim 4, further comprising:
generating, in response to said detecting the fluid leakage or the faulty sensor measurements, an alarm and control signals to isolate the leakage detection segment from a remaining portion of the pipeline network; and
performing, in response to the alarm, a root cause analysis to facilitate the maintenance operation for correcting the fluid leakage or the faulty sensor measurements.

6. The method of claim 1, further comprising:
detecting, based on the mass balance analysis result of (ΣStorage mass+(Σflowing in mass−Σflowing out mass)<ΣStorage massafter, a faulty measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

7. The method of claim 6, further comprising:
performing, in response to said detecting the faulty sensor measurements, a root cause analysis to facilitate the maintenance operation for correcting a faulty sensor in the leakage detection segment.

8. A leakage detection engine for detecting fluid leakage in an industrial facility, comprising:
a computer processor; and
memory storing instructions, when executed by the computer processor, comprising functionality for:
identifying a portion of a pipeline network as a leakage detection segment in the industrial facility, wherein all input flowpaths, all fluid storages, and all output flowpaths of the leakage detection segment belong to a plurality of fluid sensor locations where a plurality of sensors are installed in the pipeline network;
receiving, from the plurality of sensors, a plurality of fluid sensor measurements of the leakage detection segment;
analyzing, based on a mass balance criterion, the plurality of fluid sensor measurements to generate a mass balance analysis result; and
facilitating, based on the analysis result, a maintenance operation of the industrial facility.

9. The leakage detection engine of claim 8, wherein the plurality of fluid sensor measurements comprise:
an input fluid quantity through each input flowpath into the leakage detection segment;
a stored fluid quantity in each fluid storage in the leakage detection segment; and
an output fluid quantity through each output flowpath from the leakage detection segment.

10. The leakage detection engine of claim 8, the instructions, when executed by the computer processor, further comprising functionality for:
determining, based on the mass balance analysis result of (ΣStorage mass+(Σflowing in mass−Σflowing out mass)=ΣStorage massafter, that no fluid leakage is detected,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

11. The leakage detection engine of claim 8, the instructions, when executed by the computer processor, further comprising functionality for:
detecting, based on the mass balance analysis result of (ΣStorage mass+(Σflowing in mass−Σflowing out mass)>ΣStorage massafter, the fluid leakage within the leakage detection segment or a faulty sensor measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

12. The leakage detection engine of claim 11, the instructions, when executed by the computer processor, further comprising functionality for:
generating, in response to said detecting the fluid leakage or the faulty sensor measurements, an alarm and control signals to isolate the leakage detection segment from a remaining portion of the pipeline network; and
performing, in response to the alarm, a root cause analysis to facilitate the maintenance operation for correcting the fluid leakage or the faulty sensor measurements.

13. The leakage detection engine of claim 8, the instructions, when executed by the computer processor, further comprising functionality for:
detecting, based on the mass balance analysis result of (ΣStorage mass+(Σflowing in mass−Σflowing out mass)<ΣStorage massafter, a faulty measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

14. The leakage detection engine of claim 13, the instructions, when executed by the computer processor, further comprising functionality for:
performing, in response to said detecting the faulty sensor measurements, a root cause analysis to facilitate the maintenance operation for correcting a faulty sensor in the leakage detection segment.

15. An industrial facility, comprising:
a pipeline network comprising a plurality of fluid sensor locations where a plurality of sensors are installed; and
a leakage detection engine comprising functionality for:
identifying a portion of the pipeline network as a leakage detection segment in the industrial facility, wherein all input flowpaths, all fluid storages, and all output flowpaths of the leakage detection segment belong to the plurality of fluid sensor locations in the pipeline network;
receiving, from the plurality of sensors, a plurality of fluid sensor measurements of the leakage detection segment;
analyzing, based on a mass balance criterion, the plurality of fluid sensor measurements to generate a mass balance analysis result; and
facilitating, based on the analysis result, a maintenance operation of the industrial facility,
wherein the plurality of fluid sensor measurements comprise:
an input fluid quantity through each input flowpath into the leakage detection segment;
a stored fluid quantity in each fluid storage in the leakage detection segment; and
an output fluid quantity through each output flowpath from the leakage detection segment.

16. The industrial facility of claim 15, the leakage detection engine further comprising functionality for:
determining, based on the mass balance analysis result of (ΣStorage mass+(Σflowing in mass−Σflowing out mass)=ΣStorage massafter, that no fluid leakage is detected,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

17. The industrial facility of claim 15, the leakage detection engine further comprising functionality for:
detecting, based on the mass balance analysis result of (ΣStorage mass+(Σflowing in mass−Σflowing out mass)>ΣStorage massafter, the fluid leakage within the leakage detection segment or a faulty sensor measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

18. The industrial facility of claim 17, the leakage detection engine further comprising functionality for:
generating, in response to said detecting the fluid leakage or the faulty sensor measurements, an alarm and control signals to isolate the leakage detection segment from a remaining portion of the pipeline network; and
performing, in response to the alarm, a root cause analysis to facilitate the maintenance operation for correcting the fluid leakage or the faulty sensor measurements.

19. The industrial facility of claim 15, the leakage detection engine further comprising functionality for:
detecting, based on the mass balance analysis result of (ΣStorage mass+(Σflowing in mass−Σflowing out mass)<ΣStorage massafter, a faulty measurements in the plurality of fluid sensor measurements,
wherein ΣStorage mass denotes an initial sum of all stored fluid quantity in said all fluid storages in the leakage detection segment at beginning of a testing period, ΣStorage massafter denotes a final sum of all stored fluid quantity in said all fluid storages in the leakage detection segment at end of the testing period, Σflowing in mass denotes a total sum of fluid quantity flowing in through said all input flowpaths of the leakage detection segment during the testing period, and Σflowing out mass denotes a total sum of fluid quantity flowing out through said all output flowpaths of the leakage detection segment during the testing period.

20. The industrial facility of claim 19, the leakage detection engine further comprising functionality for:
performing, in response to said detecting the faulty sensor measurements, a root cause analysis to facilitate the maintenance operation for correcting a faulty sensor in the leakage detection segment.
